(19) United States
(12) Patent Application Publication
(10) Pub. No.: US 2008/0274931 A1
(43) Pub. Date: Nov. 6, 2008

(54) BIO-FRIENDLY AUTOMATIC DISH WASHING TABLETS PROCESSES AND ALL NATURAL PRODUCTS THEREBY

(75) Inventor: John Pham, Santa Ana, CA (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(73) Assignee: VERIPAK, INC., Santa Ana, CA (US)

(21) Appl. No.: 12/114,593

(22) Filed: May 2, 2008

Related U.S. Application Data
(60) Provisional application No. 60/915,637, filed on May 2, 2007.

(51) Int. Cl. C11D 17/00

(52) U.S. Cl. 510/224

(57) ABSTRACT

An improved process for manufacturing an all natural dish washing tablet having an inherent rinsing agent incorporated in the same and comprises, in combination, pre-blending sodium bicarbonate, combining the resultant blend with a plurality of granulated ingredients, adding an aliquot of liquid oil materials, including a warmed Glycerol Oleate component to create a master blend, and finishing the tablet.

### RELATED APPLICATION

This application claims full Paris Convention Priority of, and expressly reserves priority claims to U.S. Provisional Application Ser. No. 60/915,637, filed May 2, 2007, and the contents of which is hereby incorporated by reference in its entirety.

### BACKGROUND OF THE DISCLOSURE

1. Field of the Disclosure

The present disclosure relates to tablets for use in cleaning. In particular, the present disclosure offers for consideration an improved bio-friendly detergent tablet, especially effective when used with automatic dishwashing machines, which is made from all natural ingredients, and has a rinsing agent incorporated therein. This disclosure relates to processes for generating all natural dishwashing tablets, and products by the processes, inter alia.

2. General Background

Both detergent compositions and all natural products are known. However, a copious and diligent review of current product offerings and both the patent and cleaning literature have yet to reveal any viable combinations of these two concepts within the context of consumer goods for automatic dishwashing machines. Representative U.S. Pat. Nos. 7,144,851, 6,025,315 and 5,922,661 are expressly incorporated by reference as if fully set forth herein, each distinguished from the instant teachings, as shall be elucidated within the context of the instant application and claims appended hereto.

Pre-measured amounts of detergent compositions which are compressed into water-soluble table form are well known and have received substantial commercial acceptance. They generally comprise a cleaning agent such as a synthetic detergent or soap and a detergency builder which is generally sodium tripolyphosphate (STP), along with suds suppressors, soil suspending agents, bleaching agents, and other ingredients commonly added to washing compositions. They are easy to use, avoid the problem of spillage during use, and prevent the use by the consumer of too much or too little detergent. However, manufacturers of dishwashers (especially in the US) produce a wide variety dispenser cups, which cups vary in shape and size. Certain configuration of elliptical and/or oval shapes are preferred because they are more likely to be released from the cup into the wash water. This allows the entire pre-measured amounts of detergent compositions will be dissolved quickly at the beginning of the main wash cycle leading to better cleaning performance. Some tablet compositions may eventually dissolve out of the cup due to the action of hot water in the machine. However, other compositions may cake in the cup and not dissolve completely. It is widely recognized that it is most desirable to have the tablet enter the main wash as soon as possible. This will allow the cleaning agents maximum time to clean dishes and silverware.

Likewise, to artisans detergent compositions are known. While these may be in the form of a liquid or free-flowing solid such as a powder, those in the form of a tablet are now generally available. Known tablets may be of a substantially uniform composition, or may be separated into multiple phases, for example, to separate incompatible components from each other to ensure that different components are released into the wash at different times, or to provide an attractive appearance, especially when the phases have different colours. These tablets may be used, for example, in a washing machine for laundry or a dishwashing machine.

Commercially available tablets are known which have two or more layers of a compressed, granular or powdery composition. A tablet is also known which has an insert or cavity filled with a composition containing a different component from the main phase.

The layers of the tablet are formed by compression of particulate material. The cavity is formed by using any appropriately shaped upper punch, having a protrusion corresponding to the shape of the cavity.

The regions beneath and adjacent to the sides of the cavity are compressed to a greater extent than the rest of the tablet, creating an uneven distribution of densities within the tablet. As a consequence, the different portions of the tablet have undesirable different disintegration and solubilisation profiles. If the overall pressure of the upper punch used to form the cavity in the tablet is reduced, there may be an insufficient compression of the shoulders of the tablet. The tablet may then be easily damaged during storage and transport.

In sum, the present invention relates to detergent tablets and bars, and more specifically to tablets and bars of detergents which contain high levels of non-phosphate ingredients. In the past, phosphates have been used in detergents generally to avoid calcium salt precipitation. Detergents containing phosphates could be made with the same formulation in both powder and tablet form, because phosphates impart good tabletising properties. However, modernly phosphates are generally preferred to be used in detergents either at very low levels or not at all, and instead other builders such as zeolite, citrates, silicates, layered silicates, disilicates and celated compounds are employed. These builders are generally available in powder or granular form, and can easily be dry mixed or granulated in powdered detergent formulations. However, their granulometry and other physical properties are such that tabletising the powder formulation is very difficult. Hence, in order to tabletise such formulations, it has generally been necessary to reformulate the detergent, or to add binding agents to the powder before tabletising.

Examples of such binding agents include fatty alcohols or fatty acids such as lauryl alochol or stearic acid. Other formulations disclose coating a detergent tablet with a water-soluble film-forming polymer such as polyvinyl alcohol. However, they are generally difficult to use because they are solids at room temperature, and also reduce the dissolution rate of the tablet, which is undesirable in a detergent used with automatic dishwashers.

Other binders used include sodium salts of homo- or copolymeric (meth) acrylic acid, which are agglomerated with the other components of the detergent, the agglomerate then being dried and tableted. Tablets produced with such binders have improved physical and solubilization properties; however, these properties are still capable of improvement to be comparable with those of tablets which do contain phosphate builders for example.

To manufacture bar or tablet detergents extrusion is often used, and manufacturers frequently experience difficulties in maintaining satisfactory mechanical resistance in the bars, which often break during production, handling or storage.

An alternative to incorporating binders within a formulation to be tableted is to tablet the formulation and then coat the tablet with a compound which will improve its resistance to breakage and rapid dissolution. However, tablets which have only an external coating of such a material tend to dissolve too rapidly once the outer coating has been removed during the wash, which results in inferior washing results. Furthermore, coating a performed tablet is of course an extra step in the manufacturing process, which is not preferred. Others have tried coating a detergent tablet with polyoxyalkylene nonionic surfactants, although in such cases the coating is present for its surfactant properties.

Thus there remains a strong need for a detergent table containing high levels of non-phosphate builder which has suitably robust physical properties, particularly which is non-crumbling and non-dusting, which can be manufactured economically, and which provides detergency results as good as or better than existing tablets. Doing so in an all natural tablet, with organic ingredients is a desideratum. Thus there remains an unsatisfied need in the market prior to the instant teachings.

### SUMMARY OF THE DISCLOSURE

Briefly stated, a process for manufacturing an all natural dish washing tablet having an inherent rinsing agent incorporated in the same comprises, in combination, pre-blending sodium bicarbonate, combining the resultant blend with a plurality of granulated ingredients, adding an aliquot of liquid oil materials, including a warmed Glycerol Oleate component to create a master blend, and finishing the tablet. Products by the process, including those having at least about 50% less phosphates than conventional detergents (50% less phosphate per gram—4% per gram) and a weight of between at least about 5.5 and 7.5 grams, and a desired spatial configuration are effective as All Natural Automatic Dish Washing Tablets™, especially for use with automatic dishwashing machines. Likewise, artisans understand that color additives and scent may be combined with the instant teachings but are not required.

According to features of the present disclosure there are provided All Natural Automatic Dish Washing Tablets™, processes for making the same, and related usages and applications for said tablets and formulations related to the same.

According to other features of the present disclosure there are provided All Natural Automatic Dish Washing Tablets™ having at least about 50% less phosphates than conventional detergents, or up to at least about 4% per gram.

### DRAWINGS OF THE DISCLOSURE

The above-mentioned features and objects of the present invention will become more apparent with reference to the following description taken in conjunction with the accompanying drawings wherein like reference numerals denote like elements and in which:

FIG. 1 is a table showing an exemplary formulation of key ingredients of an embodiment according to the teachings of the present invention, processes and products thereby.

### DETAILED DESCRIPTION OF THE DISCLOSURE

The present inventor has discovered that a bio-friendly dishwashing product set can be formulated, entabulated and offered for consideration which is composed of all natural ingredients. As mentioned above, and discussed and claimed below, this progress satisfies a number of longstanding and unmet needs, including packetizing all natural ingredients for dishwashing purposes, which relieves environmental burdens, and offering for consideration an effective detergent, a goal of many and the accomplishment of few to date, given consumer needs, without other downstream issues.

As defined herein “all natural” means being substantially comprised of ingredients which are not synthetic and having either low-phosphate, or phosphate-free embodiments, with only surfactants and/or additional excipients which may be synthetic.

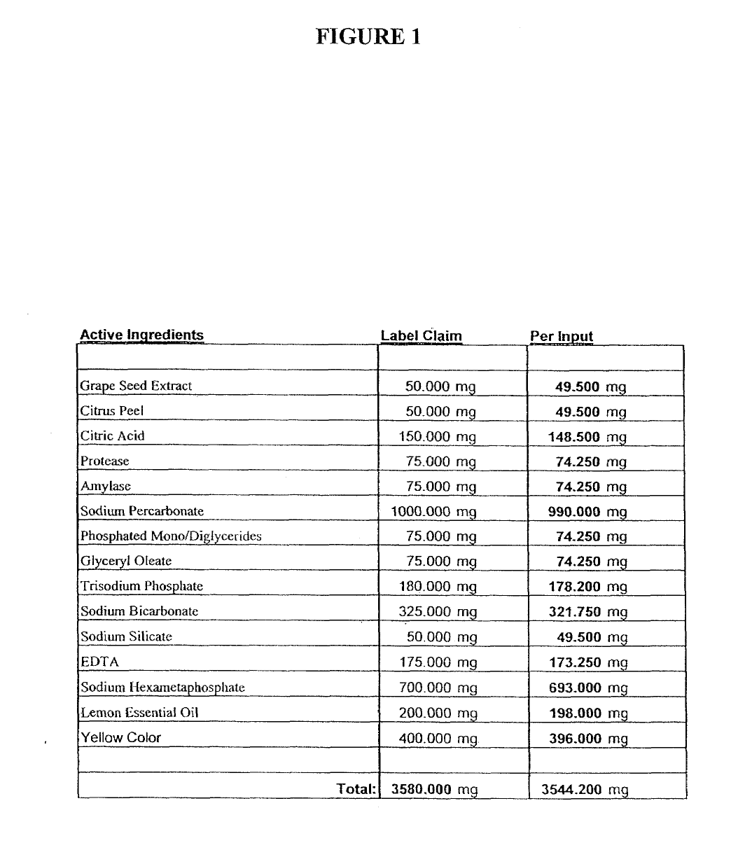

Referring now to FIG. 1, there is shown an exemplary formulation of an All Natural Automatic Dish Washing Tablet, according to the instant disclosure. As discussed, the resulting products are both safe and effective for use with automatic dishwashers, and easily fitted within known receptacles for the same. Similarly, those skilled in the art shall understand that adding color and scent is within the scope of the instant teachings. This figure is illustrative, not limiting.

By using grape seed extract, citrus peel and citric acid, along with lemon essential oil, the instant formulation compounds well without the need for many of the extraneous additives that others resort to. Likewise, testing shows that the resulting detergent effect leverages from the strength of the more traditional ingredients to satisfy the needs of retail customers in parity with known products.

Still referring also the figure, those skilled in the art will readily understand how manufacturing of the instant disclosure proceeds, based on this description, and the claims appended hereto. Namely, after protocols are followed in validating the weight and identity of all materials to be used, sodium bicarbonate if “pre-blended” to omit any trapped moisture that may be present (so as to avoid any premature chemical reactions when producing “master blend”). All “powder/crystalline/granular” ingredients are added (in no specific order). After all solid materials are fully blended, liquid oil materials are added (in no specified order) with special preparation of the glycerol oleate ingredient as this requires to be “warmed” and then “pre-blended” prior to adding to “master blend”. Upon adding of final ingredients proper amounts of time need to be allotted for even consistency of all active ingredients.

Expressly incorporated herein by reference is U.S. Pat. No. 6,025,315, as if fully set forth herein.

Longstanding needs is the art, for example, compliance with needs for and standards promulgated by leading automatic dishwashing appliance makers (Whirlpool®, Maytag®, Bosch®, and Kitchen Aid®) are within scope of the instant teachings. However, unexpectedly by lowering phosphate levels optimized release curves have been achieved whereby both improved detergent and enhanced rinsing functions have been noted.

Specifically, according to the instant teachings, the objects cleansed have been observed to be better washed and streak and spot free in comparison to those done with convention tablets. This trend is even apparent when tested against enhanced formulations having mechanical (Electrosol®, Powerball® Tabs, Powershine®, Gel Pacs®, available from Renkitt Benckiser, Inc., Parsipanny, N.J.) or other real or apparent dissolution aids. However, as discussed, the teachings of the present disclosure work better without high phosphate content. Probable mechanisms, as known to those skilled in the art, impact first the pre-soaking stage. At this stage in cleaning, food items clingingly grasp the surface.

While the apparatus and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A process for manufacturing an all natural, automatic dishwashing appliance emplacement tablet, comprising, in combination;
formulating a pre-blend of sodium bicarbonate;
adding selectively at least one ingredient from the group consisting of:
grape seed extract, citrus peel, citric acid, protease, amylase, sodium percarbonate, phosphated mono/diglycerides, trisodium phosphate, sodium bicarbonate, sodium silicate, EDTA, sodium hexametaphosphate, lemon essential oil, yellow colored excipient, and glycerol olgate;
wherein a phosphate level not to exceed at least about 4% per gram is produced in the resultant product.

2. A product by the process of claim 1.

3. A product, by the process of claim 1, wherein all of the ingredients other than phosphate related ingredients are all natural.

4. The product of claim 3, wherein complete dissolution occurs during use within an automatic dishwashing machine, at temperatures over at least about 122° C.

5. The product of claim 4, having a phosphate level of less than 10 wt. %.

6. The product of claim 4, having a phosphate level of less than 8 wt. %.

7. An improved automatic dishwashing detergent tablet which comprises, in combination:
less than 20 wt. % of a phosphate builder; and
at least about 80 wt. % of a non-phosphate builder;
wherein the remainder of the ingredients are all natural.

8. The tablet of claim 7, wherein there is no phosphate builder individual.

9. The tablet of claim 8, wherein stains are removed and no residue remains on articles washed.

10. The tablet of claim 9, further comprising at least two phases.

11. The tablet of claim 10, further comprising multiple layers.

12. The tablet of claim 11, wherein the gross geometric spatial orientation, color and packaging are customized for a particular user or set of customers.

13. An all-natural tablet for use with automatic dishwashers which comprises, in combination:
grape seed extract, organic lemon powder; lemon essential oil; citric acid;
protease; anylase; sodium percarbonate; sodium silicate; EDTA (ethylene dismine tetracetic acid); and
lauryl alcohol alkoxylate.
